(19) United States
(12) Patent Application Publication
(10) Pub. No.: US 2007/0176893 A1
(43) Pub. Date: Aug. 2, 2007

(54) METHOD IN AN INFORMATION PROCESSING APPARATUS, INFORMATION PROCESSING APPARATUS, AND COMPUTER-READABLE MEDIUM

(75) Inventor: Noriaki Sato, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/627,027

(22) Filed: Jan. 25, 2007

(30) Foreign Application Priority Data
Jan. 31, 2006 (JP) 2006-023621
Dec. 12, 2006 (JP) 2006-335080

(51) Int. Cl. G09G 5/00

(52) U.S. Cl. 345/156

(57) ABSTRACT

An information processing apparatus transmits and receives drawing data with another information processing apparatus connected via a network and can share display contents to be displayed on a display unit based on each other's drawing data. The information processing apparatus receives drawing data via the network, and stores first drawing data and second drawing data in a storage unit. The information processing apparatus updates the first and second drawing data stored in the storage unit. The information processing apparatus executes display control of first display contents based on the updated first drawing data and second display contents based on the updated second drawing data on the display unit.

### BACKGROUND OF THE INVENTION

1. Field of the Invention

The present invention relates to an information processing technique and, more particularly, to an information processing technique for identifiably displaying temporarily drawn contents and permanently drawn contents while assuring a time period until the temporarily drawn contents fade out by controlling drawing processing, update processing, and fade-out processing based on drawing data of respective information processing apparatuses.

2. Description of the Related Art

A shared whiteboard system which allows a plurality of information processing apparatuses to display common screen contents by exchanging drawing data among these processing apparatuses connected to a network, and synchronizing drawing processing by the self apparatus with that of other apparatuses is available. In some shared whiteboard systems of this type, the contents of the displayed common screen contents automatically fade out after an elapse of a predetermined period of time. For example, Japanese Patent Laid-Open No. 10-108154 has proposed a system which automatically fades out the contents, which are temporarily drawn from the self apparatus to give an explanation to the user of another information processing apparatus, after an elapse of a predetermined period of time without any fade-out operation from the self apparatus side.

In the conventional shared whiteboard system, since the temporarily drawn contents automatically fade out if the user visually confirms them within a predetermined period of time, a relatively long period of time until automatic fade-out need be set so as to facilitate user's visual confirmation and understanding of the contents.

However, in the conventional shared whiteboard system, if a long period of time is assured until automatic fade-out processing, the user misidentifies temporarily drawn contents and permanently drawn contents. If the user draws some contents while he or she misidentifies temporarily drawn contents for permanently drawn contents, the system fades out the drawn contents that he or she intended to store, and the user must draw the contents again from the beginning.

### SUMMARY OF THE INVENTION

An embodiment of the present invention provides a technique for identifiably displaying temporarily drawn contents and permanently drawn contents while assuring a time period until the temporarily drawn contents fade out by controlling drawing processing, update processing, and fade-out processing based on drawing data of respective information processing apparatuses.

According to an aspect of the present invention, an embodiment is directed to a method in an information processing apparatus which is capable of transmitting and receiving drawing data with another information processing apparatus connected via a network and can share display contents to be displayed on a display unit based on each other's drawing data. The method includes: inputting the drawing data; storing first drawing data input and second drawing data received via the network, the first drawing data and the second drawing data stored in a storage unit; updating the first drawing data stored in the storage unit; updating the second drawing data stored in the storage unit; and displaying, on the display unit, first display contents based on the updated first drawing data and second display contents based on the updated second drawing data.

According to another aspect of the present invention, the user can identify temporarily drawn contents and permanently drawn contents while assuring a time period until the temporarily drawn contents fade out by controlling drawing processing, update processing, and fade-out processing based on drawing data of respective information processing apparatuses.

Further features of the present invention will become apparent from the following description of exemplary embodiments with reference to the attached drawings.

### BRIEF DESCRIPTION OF THE DRAWINGS

FIG. 1 is a schematic diagram showing the arrangement of an information processing system according to one embodiment of the present invention;

FIG. 2 is a block diagram showing the arrangement of an information processing apparatus shown in FIG. 1;

FIG. 3 is a flowchart for explaining the procedure of drawing processing according to the embodiment of the present invention;

FIG. 4A is a flowchart for explaining the procedure of mouse event processing of trail A according to the first embodiment;

FIG. 4B shows the relationship between the number n of coordinate points and coordinate number limit Na;

FIG. 5 is a flowchart for explaining the procedure of fade-out processing of trail A according to the first embodiment;

FIG. 6 is a flowchart for explaining the procedure of update processing of drawn contents according to the first embodiment;

FIG. 7 shows an example of drawn coordinate sequence A used to store drawn point coordinates;

FIG. 8A shows an example of the displayed contents on a display 205a, and FIG. 8B shows an example of the displayed contents on a display 205b of another terminal;

FIG. 9A is a flowchart showing the procedure of drawing processing of trail B according to the first embodiment;

FIG. 9B shows the relationship between the number m of coordinate points and coordinate number limit Nb;

FIG. 10 is a flowchart showing the procedure of fade-out processing of trail B according to the first embodiment;

FIG. 11 shows drawn coordinate sequence B used to store drawn point coordinates which are required to display trail B;

FIG. 12 is a flowchart for explaining the procedure of mouse event processing of trail A according to the second embodiment;

FIG. 13 is a flowchart for explaining the procedure of fade-out processing according to the second embodiment;

FIG. 14 is a flowchart for explaining the procedure of the drawing update processing according to the second embodiment;

FIG. 15 shows an example of drawn line segment sequence A used to store line segment data (the coordinates of start and end points), which are required to display trail A;

FIG. 16A shows an example of the displayed contents on a display 205a, and FIG. 16B shows an example of the displayed contents on a display 205b of another terminal;

FIG. 17 is a flowchart for explaining the procedure of drawing processing of trail B according to the second embodiment;

FIG. 18 is a flowchart for explaining the procedure of fade-out processing of trail B according to the second embodiment;

FIG. 19 shows an example of drawing lien segment sequence B used to store line segment data (the coordinates of start and end points), which are required to display trail B;

FIG. 20 is a flowchart for explaining the procedure of detailed mouse event processing of trail A according to the third embodiment;

FIG. 21 is a flowchart for explaining the procedure of drawing processing of trail B according to the third embodiment;

FIG. 22 is a flowchart for explaining the procedure of drawing processing of trail B according to the fourth embodiment;

FIG. 23 is a flowchart for explaining the procedure of fade-out processing of trail B according to the fourth embodiment;

FIG. 24 shows an example of a drawn coordinate sequence according to the fifth embodiment; and

FIG. 25 shows an example of a drawn line segment sequence according to the fifth embodiment.

### DESCRIPTION OF THE EMBODIMENTS

### First Exemplary Embodiment

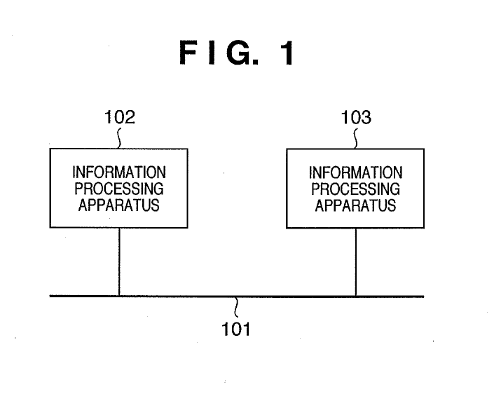

Preferred embodiments of the present invention will be described in detail hereinafter with reference to the accompanying drawings. FIG. 1 is a schematic diagram showing the arrangement of an information processing system according to one embodiment of the present invention. Information processing apparatuses 102 and 103 are connected via a network 101 and can make bi-directional communications of data including drawing data. The network 101 is a wired or wireless network which allows bi-directional communications between the information processing apparatuses 102 and 103.

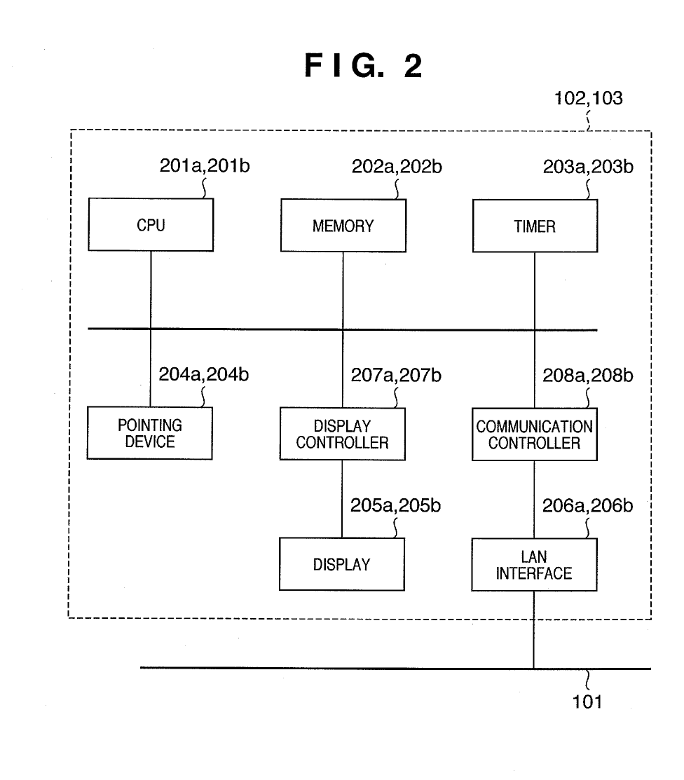

FIG. 2 is a block diagram showing the arrangement of the information processing apparatus 102 or 103 shown in FIG. 1. To avoid repetitive descriptions, “a” is attached to reference numerals of the building components of the information processing apparatus 102, and “b” is attached to those of the information processing apparatus 103.

In the description of FIG. 2, the information processing apparatus 102 is explained as a representative apparatus. However, functions implemented by the corresponding components in the information processing apparatus 103 are the same as those in the information processing apparatus 102. Referring to FIG. 2, reference numeral 201a denotes a CPU which controls the entire information processing apparatus 102 in accordance with programs. The CPU 201a can control storage of drawing data in a memory 202a (to be described below).

Reference numeral 202a denotes a memory which stores a display control program, display data, and the like. The memory 202a includes a RAM or the like, which can serve as a work area upon execution of programs by the CPU 201a in addition to a ROM, hard disk, and the like, which pre-store the display data, display control program, and the like.

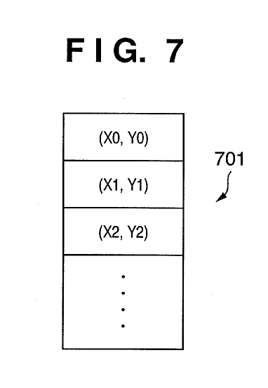

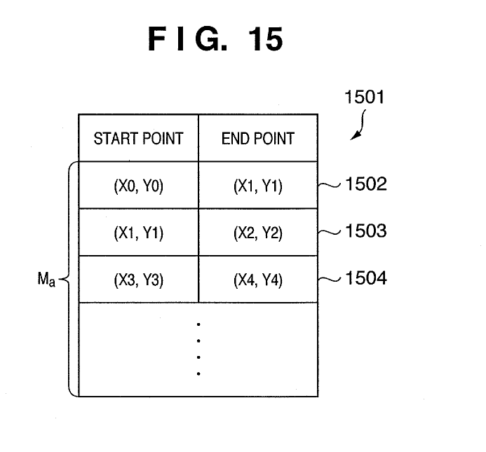

Assume that the memory 202a includes storage areas used to independently store drawing data input on the information processing apparatus 102 side, and drawing data sent from another information processing apparatus 103. Also, drawn coordinate sequences A, B, and the like (FIGS. 7, 11, and 24) and drawn line segment sequences A, B, and the like (FIGS. 15, 19, and 25) are stored in the storage areas of the memory 202a.

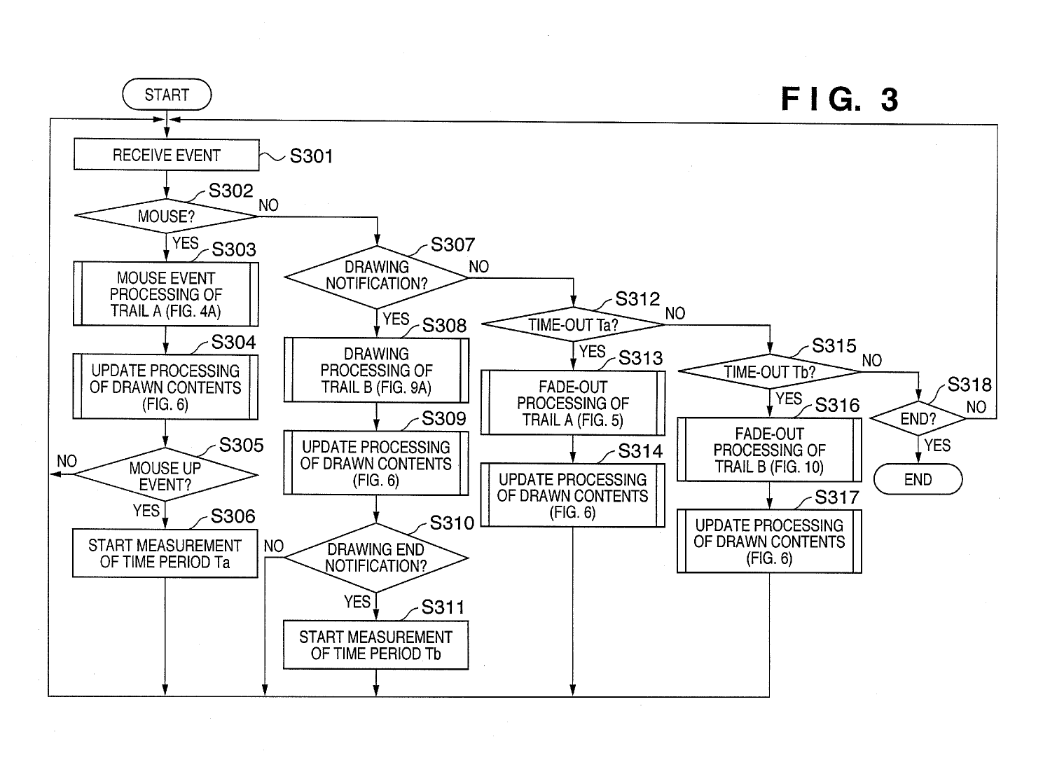

Reference numeral 203a denotes a timer (time measuring unit) which can manage a plurality of time periods required to control display. Once the timer 203a is started, it keeps generating a time-out event at predetermined time intervals (e.g., Ta and Tb in FIG. 3) until it receives an end instruction. Reference numeral 204a denotes a pointing device which is used to input coordinates, and includes input devices such as a keyboard, mouse, and the like.

Reference numeral 205a denotes a display monitor (to be referred to as “display” hereinafter) of the information processing apparatus 102, which visually displays drawing data under the control of a display controller 207a. The display 205a can visually display drawing data of the self apparatus, which is input by the user via the pointing device 204a and drawing data, which is received from another apparatus (in this case, the information processing apparatus 103).

The display contents of the display 205a are transmitted to the other information processing apparatus 103 via a LAN interface 206a and the network 101 under the control of the display controller 207a and a communication controller 208a. The display contents based on drawing data exchanged between the apparatuses can be shared between the information processing apparatuses 102 and 103. The shared display contents will be referred to as a “shared whiteboard” hereinafter, and the system including the information processing apparatuses 102 and 103 will also be referred to as a “shared whiteboard system” hereinafter.

The procedure of practical processing for displaying drawing data on the display 205a of the information processing apparatus 102 as a self terminal, and sharing display of drawing data by transmitting this drawing data to the information processing apparatus 103 will be described below.

The information processing apparatus 103 receives as the other terminal drawing data sent from the information processing apparatus 102, and displays the received drawing data on a display 205b under the control of a display controller 207b. In the following description, assume that a first trail (to be referred to as “trail A” hereinafter represents a trail of drawing made on the self terminal (information processing apparatus 102), and a second trail (to be referred to as “trail B” hereinafter represents a trail of drawing made on the other terminal (information processing apparatus 103).

While the display contents on both the displays 205a and 205b of the information processing apparatuses 102 and 103 as the shared whiteboards are shared, the display 205a on the information processing apparatus 102 side displays trail B in addition to trail A under the control of the display controller 207a. Likewise, the display 205b on the information processing apparatus 103 side displays trail A in addition to trail B under the display control of the display controller 207b.

The procedure of processing executed when the information processing apparatus 102 executes drawing processing for the self terminal on the display 205a of the self terminal and drawing processing based on drawing data received from the other terminal will be described below with reference to the flowchart of FIG. 3. The drawing data on the self terminal is sent to the other terminal. The other terminal side displays drawn contents on that terminal and those based on the received drawing data on its display, thus sharing the drawn contents between the two terminals. The display controller 207a and communication controller 208a execute the following processing under the total control of the CPU 201a.

In step S301, the CPU 201a receives a generated event. The CPU 201a can receive an event from the pointing device 204a, a time-out event from the timer 203a, a drawing notification event that notifies reception of drawing data from the LAN interface 206a, and the like.

The CPU 201a determines in step S302 if the received event is a mouse event (an event generated when the user moves the mouse or clicks a button) from the pointing device 204a. If the received event is a mouse event (YES in step S302), the process advances to step S303; otherwise (NO in step S302), the process advances to step S307.

Note that the processes in steps S303 to S306 which are executed if the received event is a mouse event indicate the processing steps associated with drawing processing on the self terminal.

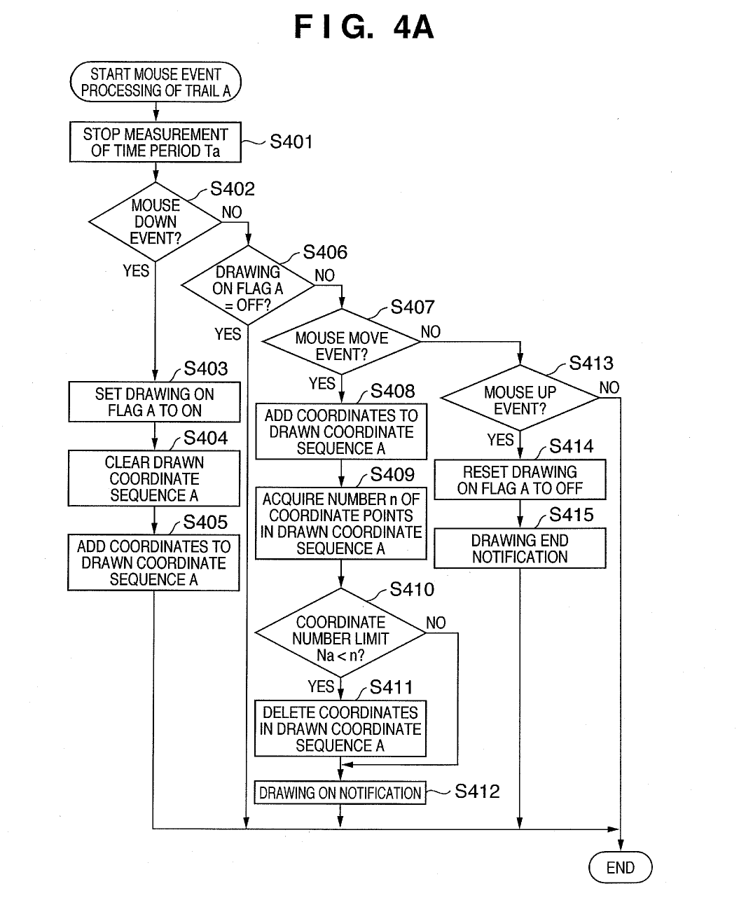

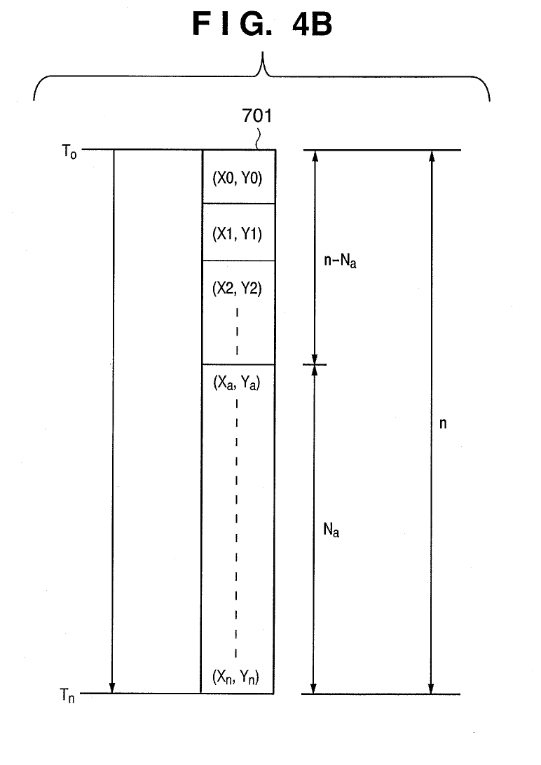

In step S303, the CPU 201a executes processing for drawing a record (trail A) of coordinates associated with the drawn contents to be displayed on the display 205a by the mouse event (this processing will be referred to as “mouse event processing” hereinafter). Since details of the mouse event processing of trail A will be described below with reference to the flowchart of FIG. 4A, a description thereof will be omitted herein.

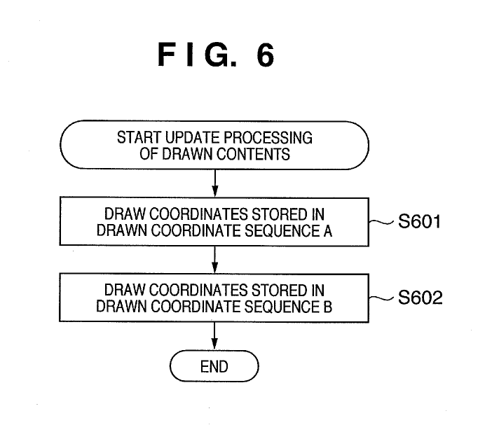

In step S304, the display controller 207a updates the drawn contents of trail A based on the previous mouse event processing in step S303. Note that the update processing of the drawn contents will be described later with reference to the flowchart of FIG. 6, and a description thereof will be omitted herein.

The CPU 201a determines in step S305 if the received event is a mouse up event (an event generated when the user releases the mouse button and ends an operation associated with drawing) from the pointing device 204a. If the CPU 201a determines in step S305 that the received event is a mouse up event (YES in step S305), the process advances to step S306; otherwise (NO in step S305), the process returns to step S301.

If the received event is a mouse event (YES in step S305), the process proceeds to step S306. In step s306, the CPU 201a starts measurement of the timer 203a if the timer 203a stops measurement of time period Ta.

Note that time period Ta is a time interval required to fade out trail A displayed on the display 205a of the self terminal.

In this way, display (or re-display) of trail A drawn on the self terminal fades out since the fade-out processing in step S313 is executed every time a time-out event is generated in response to an elapse of time period Ta.

Note that time period Ta is a predetermined period of time. Time period Ta may be calculated based on the drawing speed of trail A. If the user draws trail A quickly, trail A is controlled to fade out quickly; if he or she draws trail A slowly, trail A is controlled to fade out slowly, thus improving the visual effect.

On the other hand, the CPU 201a determines in step S307 if the received event is a drawing notification event that notifies reception of drawing data via the LAN interface 206a. If the received event is a drawing notification event (YES in step S307), the process advances to step S308; otherwise (NO in step S307, the process advances to step S312.

Note that steps S308 to S311 executed when the received event is a drawing notification event are the processing steps for executing the drawing processing executed on the other terminal (e.g., the information processing apparatus 103) on the display 205a based on the received drawing data.

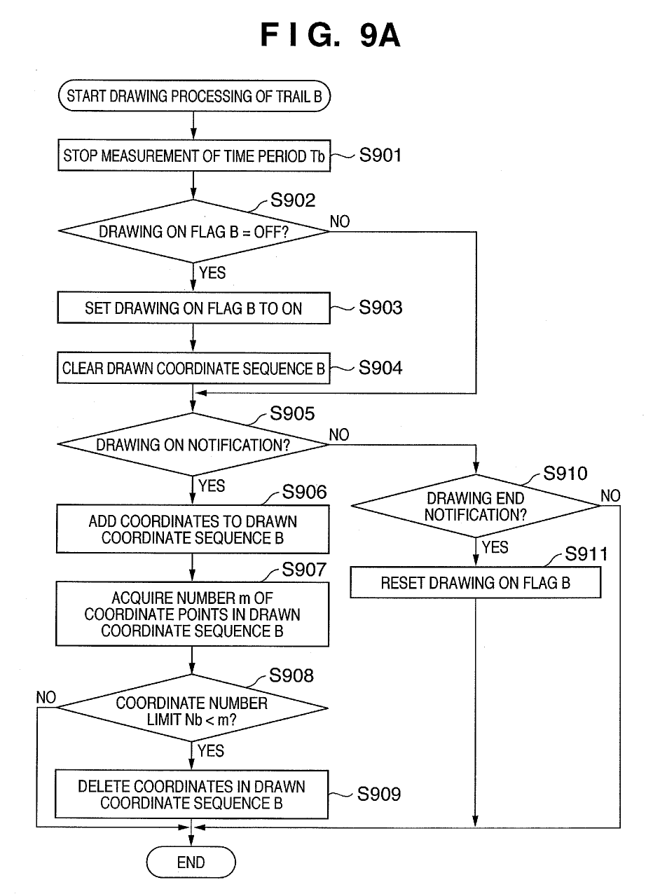

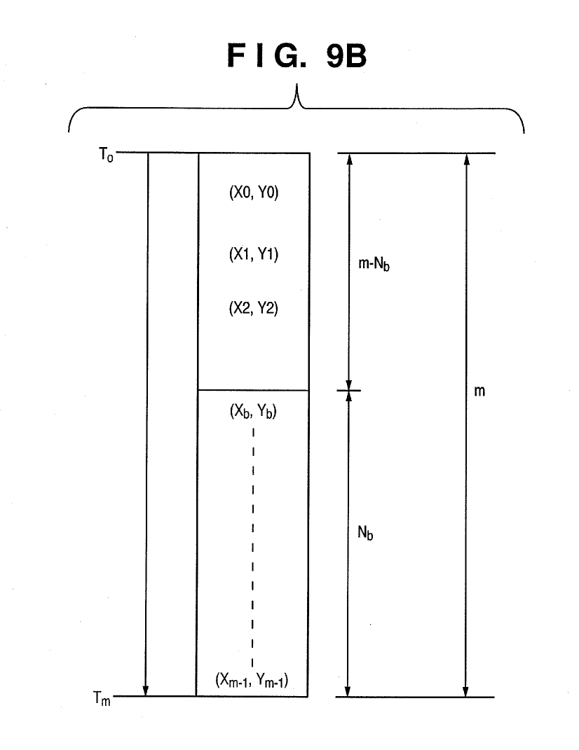

In step S308, the CPU 201a executes processing for drawing a record (trail B) of coordinates based on the received drawings data. Details of the processing of the drawing data associated with trail B will be described later with reference to the flowchart of FIG. 9A, and a description thereof will be omitted herein.

In step S309, the display controller 307a updates the drawn contents of trail B based on the previous processing in step S308. Note that details of the update processing of the drawn contents follow those in the flowchart of FIG. 6 as in step S304, and a detailed description thereof will be omitted herein.

The CPU 201a determines in step S310 if the drawing notification event is an event that notifies the end of drawing processing. If the drawing notification event is not an event that notifies the end of drawing processing (NO in step S310), the process returns to step S301 to repeat the same processing. On the other hand, if the CPU 201a determines that the drawing notification event is an event that notifies the end of drawing processing (YES in step S310), the process proceeds to step S311. In step S311. The CPU 201a starts measurement of the timer 203a if the timer 203a stops measurement of time period Tb.

Note that time period Tb is a time interval required to fade out trail B displayed on the display 205a of the self terminal.

In this way, display (or re-display) of trail B drawn on the other terminal fades out since the fade-out processing in step S316 is executed every time a time-out event is generated in response to an elapse of time period Tb. Note that time period Tb is a predetermined period of time.

Time period Tb may be calculated based on the drawing speed of trail B. If the user draws trail B quickly, trail B is controlled to fade out quickly; if he or she draws trail B slowly, trail B is controlled to fade out slowly, thus improving the visual effect.

The CPU 201a determines in step S312 if the received event is a time-out event generated in response to an elapse of time period Ta measured by the timer 203a. If the CPU 201a determines in step S312 that the received event is not a time-out event generated in response to an elapse of time period Ta (NO in step S312), the process advances to step S315; otherwise (YES in step S312), the process advances to step S313.

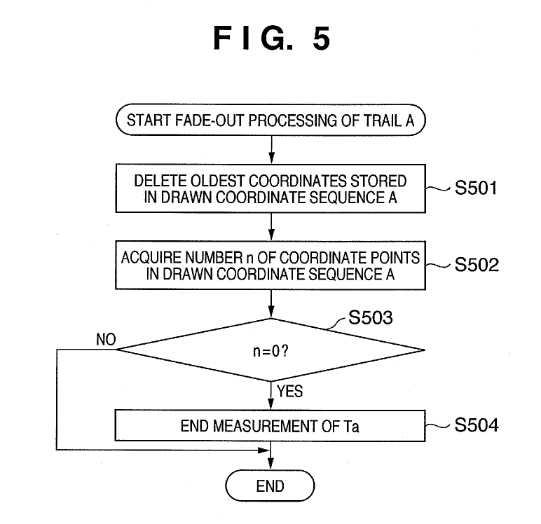

In step S313, the display controller 207a executes fade-out processing of trail A. Since details of the fade-out processing of trail A will be described later with reference to the flowchart of FIG. 5, a description thereof will be omitted herein.

In step S314, the CPU 201a updates the drawn contents of trail A under the display control of the display controller 207a. Note that the update processing of the drawn contents of trail A will be described later with reference to the flowchart of FIG. 6, and a description thereof will be omitted herein.

The CPU 201a determines in step S315 if the received event is a time-out event generated in response to an elapse of time period Tb measured by the timer 203a. If the CPU 201a determines in step S315 that the received event is not a time-out event generated in response to an elapse of time period Ta (NO in step S315), the process advances to step S318; otherwise (YES in step S315), the process advances to step S316.

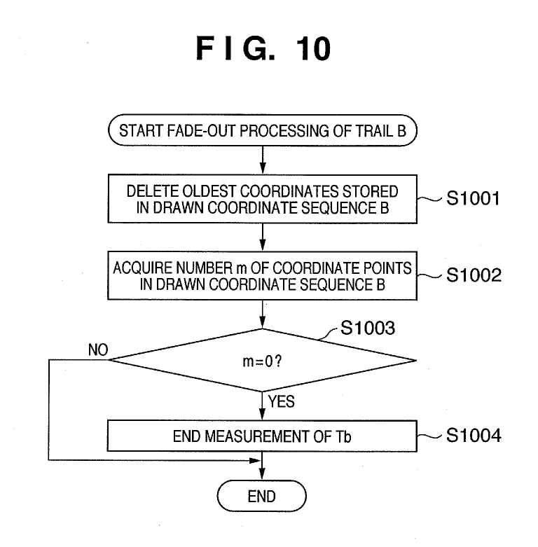

In step S316, the display controller 207a executes fade-out processing of trail B. Since details of the fade-out processing of trail B will be described later with reference to the flowchart of FIG. 10, a description thereof will be omitted herein.

In step S317, the CPU 201a updates the drawn contents of trail B under the display control of the display controller 207a. Note that the update processing of the drawn contents of trail B will be described later with reference to the flowchart of FIG. 6 as in step S314, and a description thereof will be omitted herein.

If the CPU 201a determines in step S318 that the received event is an end event (YES in step S318), it ends processing. On the other hand, if the CPU 201a determines in step S318 that the received event is not an end event (NO in step S318), the process returns to step S301 to repeat the same processing.

(Mouse Event Processing of Trail A)

The procedure of the detailed mouse event processing in step S303 in FIG. 3 will be described below with reference to FIGS. 4A and 4B. FIG. 4A is a flowchart for explaining the procedure of the detailed mouse event processing of trail A. Note that the display controller 207a and communication controller 208a execute the following processing under the total control of the CPU 201a.

In step S401, the timer 203a stops measurement of time period Ta until the drawn contents on the display 205a of the self terminal fade out.

The CPU 201a determines in step S402 if the received event is a mouse down event (an event generated when the user presses the mouse button to start an operation associated with drawing) from the pointing device 204a. If the received event is not a mouse down event (NO in step S402), the process advances to step S406; otherwise (YES in step S402), the process advances to step S403.

In step S403, the CPU 201a sets flag A indicating that drawing of trail A is in progress to ON.

In step S404, the CPU 201a clears drawn coordinate sequence A used to store drawn point coordinates. FIG. 7 shows an example of a drawn coordinate sequence A 701 used to store drawn point coordinates. The drawn coordinate sequence A 701 can store coordinates inputs by the pointing device 204a in turn as position coordinates (x- and y-coordinates), and is cleared to zero (initialized) by the processing of this step.

In step S405, the CPU 201a sequentially stores (adds) the position coordinates input by the mouse down event at the first address of the drawn coordinate sequence A 701.

On the other hand, the CPU 201a determines in step S406 if the flag A is OFF. If the flag A is OFF (YES in step S406), the CPU 201a ends the mouse event processing of trail A. If the flag A is not OFF (NO in step S406), the CPU 201a determines in step S407 if the received event is a mouse move event (an event associated with an operation for moving the mouse) from the pointing device 204a.

If the received event is not a mouse move event (NO in step S407), the process advances to step S413. On the other hand, if the received event is a mouse move event (YES in step S407), the CPU 201a sequentially adds the position coordinates input by the mouse move event to the rearmost address of the drawn coordinate sequence A 701 in step S408.

In step S409, the CPU 201a acquires the number n of coordinate points stored in the drawn coordinate sequence A 701. The CPU 201a then determines in step S410 if the number n of coordinate points acquired from the drawn coordinate sequence A 701 exceeds a coordinate number limit Na of trail A. If the number n of coordinate points exceeds the coordinate number limit Na of trail A (YES in step S410), the CPU 201a sequentially deletes coordinate data from those (the number n of coordinate points) stored in the drawn coordinate sequence A 701 by the number which has exceeded the coordinate number limit Na in step S411.

FIG. 4B shows the relationship between the number n of coordinate points and coordinate number limit Na. In response to the mouse move event, the drawn coordinate sequence A 701 stores n coordinate data (x0, y0), (x1, y1), . . . , (xn−1, xn−y) from time T0 to time Tn. If the number of coordinate points has exceeded the coordinate number limit Na, a corresponding number of oldest coordinate data ((n−Na) in case of FIG. 4B) stored in the drawn coordinate sequence A 701 are sequentially deleted. Of the number n of coordinate points stored in the drawn coordinate sequence A 701, display of trail A undergoes display control to have the coordinate number limit Na as an upper limit. Every time new coordinate data is added to the drawn coordinate sequence A 701, the oldest coordinate data is deleted sequentially. The display controller 207a controls to fade out display corresponding to the oldest coordinate data, and controls to display trail A corresponding to the new coordinate data added to the drawn coordinate sequence A 701 on the display 205a.

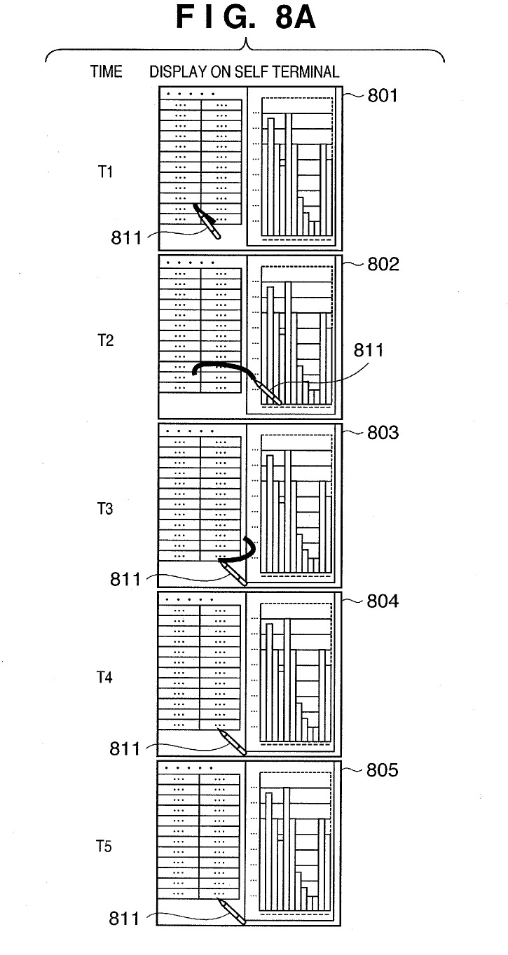

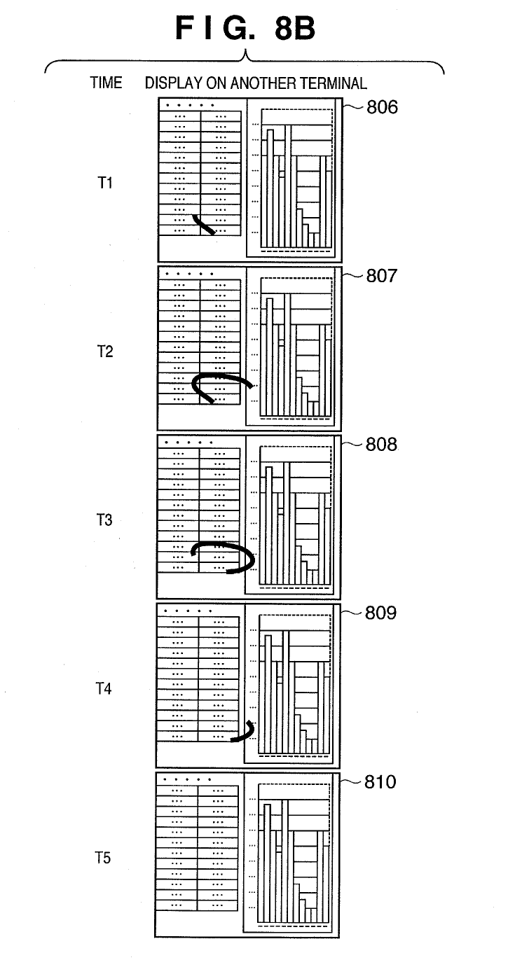

FIG. 8A shows an example of the displayed contents on the display 205a. Reference numerals 801 to 805 denote drawing states on the self terminal (information processing apparatus 102), on which drawing is underway, in a time series (T1 to T5). On the drawing states 801 to 805, reference numeral 811 denotes a cursor displayed on the display 205a of the information processing apparatus 102, and trail A is drawn on the display 205a by dragging this cursor. Trail A, which is drawn by dragging the cursor 811, is drawn as a trail of position coordinates for the coordinate number limit Na while tracing back from the latest coordinates under the control of the display controller 207a.

FIG. 8B shows an example of the displayed contents on the display 205b of the other terminal. Reference numerals 806 to 810 denote drawing states of the contents drawn on the self terminal (information processing apparatus 102) on the display 205b in a time series (T1 to T5).

Referring back to FIG. 4A, in step S412 the CPU 201a sends a drawing ON notification indicating that drawing is in progress on the self terminal to the other information processing apparatus 103 via the LAN interface 206a, thus ending the processing.

On the other hand, the CPU 201a determines in step S413 if the received event is a mouse up event from the pointing device 204a. If the received event is a mouse up event (YES in step S413), the process advances to step S414. On the other hand, if the received event is not a mouse up event (NO in step S413), the processing ends.

In step S414, the CPU 201a resets the flag A indicating that drawing of trail A is in progress to OFF. In step S415, the CPU 201a sends a drawing end notification indicating that drawing has ended to the information processing apparatus 103 via the LAN interface 206a, thus ending the processing.

(Fade-Out Processing of Trail A)

The fade-out processing of trail A in step S313 in FIG. 3 will be described below with reference to FIG. 5. FIG. 5 is a flowchart for explaining the procedure of the detailed fade-out processing of trail A according to this embodiment. Note that the display controller 207a and communication controller 208a execute the following processing under the total control of the CPU 201a.

In step S501, the CPU 201a deletes the oldest coordinates stored in the drawn coordinate sequence A 701 in response to the time-out event of time period Ta. With this processing, the CPU 201a deletes the coordinate points stored in the drawn coordinate sequence A 701 in turn from the oldest coordinates every time period Ta set in the timer 203a. The display controller 207a controls display on the display 205a to fade out display corresponding to the coordinates deleted every time period Ta by reflecting the coordinate delete processing.

In step S502, the CPU 201a acquires the number n of coordinate points in the drawn coordinate sequence A 701.

The CPU 201a determines in step S503 if the number n of coordinate points in the drawn coordinate sequence A 701 is zero. If n=0 (YES in step S503), the timer 203a ends measurement of time period Ta in step S504. The CPU 201a passes the data of the number n of coordinate points acquired in step S502 to the processing (S314 in FIG. 3; FIG. 6) for updating display of trail A as a result of the fade-out processing.

(Update Drawn Contents)

The update processing of the drawn contents (trails A and B) in steps S304, S309, S314, and S317 in FIG. 3 will be described below with reference to FIG. 6. FIG. 6 is a flowchart for explaining the procedure of the update processing of the drawn contents according to this embodiment. Note that the display controller 207a and communication controller 208a execute the following processing under the total control of the CPU 201a.

In step S601, the CPU 201a reads out coordinate data stored in the drawn coordinate sequence A 701 and controls to display drawn contents by connecting the respective readout coordinates by a straight line or curve on the display 205a as trail A.

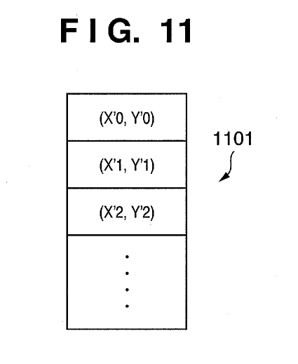

In step S602, the CPU 201a reads out coordinate data from a drawn coordinate sequence B 1101 (which stores position coordinates input in response to the mouse down event on the information processing apparatus 103 side) shown in FIG. 11. The CPU 201a then controls to display drawn contents by connecting the readout coordinates by a straight line or curve on the display 205a as trail B.

Upon displaying trails A and B, the display controller 207a can change display of the color, width, and the like of the straight lines or curves that connect the coordinates based on the order of coordinates stored in the respective drawn coordinate sequences. Upon identifiably displaying trails A and B, the visual effect of the fade-out processing can be improved.

(Drawing Processing of Trail B)

The procedure of the detailed drawing processing in step S308 in FIG. 3 will be described below with reference to FIG. 9A. FIG. 9A is a flowchart for explaining the procedure of the detailed drawing processing of trail B. Note that the display controller 207a and communication controller 208a execute the following processing under the total control of the CPU 201a.

In step S901, the timer 203a stops measurement of time period Tb required to fade out the drawn contents on the other terminal.

The CPU 201a determines in step S902 if flag B indicating that drawing of trail B on the other terminal is underway is OFF. If the flag B is OFF (YES in step S902), the process advances to step S903; otherwise (NO in step S902), the process jumps to step S905.

The CPU 201a sets the flag B to ON in step S903, and clears drawn coordinate sequence B 1101 used to store the drawn point coordinates required to display trail B in step S904.

FIG. 11 shows the drawn coordinate sequence B 1101 used to store drawn point coordinates required to display trail B. The drawn coordinate sequence B 1101 can sequentially store coordinates input by a pointing device 204b as position coordinates (x- and y-coordinates), and the processing of this step clears (initializes) the drawn coordinate sequence B 1101 to zero.

The CPU 201a determines in step S905 if the received event is a drawing ON notification event, which indicates that drawing is in progress, from the information processing apparatus 103 via the LAN interface 206a. If the received event is a drawing ON notification event (YES in step S905), the process advances to step S906. If the CPU 201a determines in step S905 that the received event is not a drawing ON notification event (NO in step S905), the process advances to step S910.

In step S906, the CPU 201a sequentially stores (adds) the coordinates of drawing data sent from the information processing apparatus 103 to the rearmost address of the drawn coordinate sequence B 1101.

In step S907, the CPU 201a acquires the number m of coordinate points stored in the drawn coordinate sequence B 1101. The CPU 201a then determines in step S908 if the number m of coordinate points acquired from the drawn coordinate sequence B 1101 exceeds a coordinate number limit Nb of trail B.

If the number m of coordinate points exceeds the coordinate number limit Nb of trail B (YES in step S908), the CPU 201a sequentially deletes coordinate data from those (the number m of coordinate points) stored in the drawn coordinate sequence B 1101 by the number which has exceeded the coordinate number limit Nb in step S909.

FIG. 9B shows the relationship between the number m of coordinate points and coordinate number limit Nb. In response to the drawing processing on the information processing apparatus 103, the drawn coordinate sequence B 1101 stores m coordinate data (x0, y0), (x1, y1), . . . , (xm−1, xm−y) from time T0 to time Tm. If the number of coordinate points has exceeded the coordinate number limit Nb, a corresponding number of oldest coordinate data ((m−Nb) in case of FIG. 9B) stored in the drawn coordinate sequence B 1101 are sequentially deleted. Of the number m of coordinate points stored in the drawn coordinate sequence B 1101, display of trail B undergoes display control to have the coordinate number limit Nb as an upper limit. Every time new coordinate data is added to the drawn coordinate sequence B 1101, the oldest coordinate data is deleted sequentially. The display controller 207a controls to fade out display corresponding to the oldest coordinate data, and controls to display trail B corresponding to the new coordinate data added to the drawn coordinate sequence B 1101 on the display 205a.

Based on the relationship shown in FIG. 9B, trail B is drawn while being tracing back from the latest coordinates (xm−1, ym−1) to the previously input coordinates (xb, yb) for the coordinate number limit Nb. By setting the coordinate number limit Nb of trail B to be larger than the coordinate number limit Na of trail B, trail B longer than trail A can be displayed.

For example, if the coordinate number limit Na of trail A is set to be 0, no trail is displayed on the display 205a of the information processing apparatus 102 on the self terminal side on which the drawing operation is made, and a trail is displayed only on the information processing apparatus 103 on the other terminal side. Such display method is available.

Assume that the coordinate number limit Nb of trail B is set to be a maximum value that the information processing apparatus 103 can process. In this case, the trail is controlled to fade out on the display 205a of the information processing apparatus 102 on the self terminal side on which the drawing operation is made, and the trail is controlled not to fade out on the display 205b of the information processing apparatus 103 on the other terminal side until the drawing operation ends. Such display method is also available.

On the other hand, the CPU 201a determines in step S910 if the received event is a drawing end notification event from the LAN interface 206a. If the received event is a drawing end notification event (YES in step S910), the process advances to step S911, and the CPU 201a resets the flag B indicating that drawing of trail B is in progress, thus ending the processing. If the CPU 201a determines in step S910 that the received event is not a drawing end notification event (NO in step S910), it ends this processing and starts the next update processing of the drawn contents (FIG. 6).

(Fade-Out Processing of Trail B)

The fade-out processing of trail B in step S316 in FIG. 3 will be described below with reference to FIG. 10. FIG. 10 is a flowchart for explaining the procedure of the detailed fade-out processing of trail B according to this embodiment. Note that the display controller 207a and communication controller 208a execute the following processing under the total control of the CPU 201a.

In step S1001, the CPU 201a deletes the oldest coordinates stored in the drawn coordinate sequence B 1101 in response to the time-out event of time period Tb. With this processing, the CPU 201a deletes the coordinate points stored in the drawn coordinate sequence B 1101 in turn from the oldest one every time period Tb set in the timer 203a. The display controller 207a controls display on the display 205a to fade out display corresponding to the coordinates deleted every time period Tb by reflecting the coordinate delete processing.

In step S1002, the CPU 201a acquires the number m of coordinate points in the drawn coordinate sequence B 1101.

The CPU 201a determines in step S1003 if the number m of coordinate points in the drawn coordinate sequence B 1101 is zero. If m=0 (YES in step S1003), the timer 203a ends measurement of time period Tb in step S1004. The CPU 201a passes the data of the number m of coordinate points acquired in step S1002 to the processing (S317 in FIG. 3; FIG. 6) for updating display of trail B as a result of the fade-out processing.

This embodiment has explained the example in which trail B based on drawing data from the other terminal (information processing apparatus 103) is displayed in addition to trail A of the self terminal (information processing apparatus 102). The gist of the present invention is not limited to such specific example. The present invention can be similarly applied to a case wherein the information processing apparatus 103 is defined as a self terminal, drawn contents on the information processing apparatus 103 are defined as trail A, and trail B based on drawing data received from the information processing apparatus 102 as the other terminal is displayed.

Furthermore, the contents drawn on other terminals in the arrangement including more information processing apparatuses can be added as trail C, trail D, and the like, and these trails can be identifiably displayed on one display. In this case, the memory 202a includes drawn coordinate sequences C, D, and the like used to store corresponding drawing data, so that the display controller 207a can display the drawing data stored in the respective drawn coordinate sequences on the display 205a. By exchanging drawing data among a plurality of information processing apparatuses, the contents drawn on the display can be shared.

The coordinate number limit Na of trail A and the coordinate number limit Nb of trail B can be set for respective information processing apparatuses. When the user wants to perform the drawing operation on the self terminal without drawing any trail of the other terminal, Nb is set to be zero not to draw any trail from the other terminal. When the coordinate number limit Nb of the other terminal, which is set in the self terminal is set to have the same value as the coordinate number limit Na of the self terminal, the same screen display contents can be displayed on the displays of the self terminal and the other terminal.

By setting a small coordinate number limit Na to fade out trail A at once, the user can easily decide as to whether trail A is drawn temporarily or permanently. On the other hand, by setting a large coordinate number limit Nb to slowly fade out trail B, the user can easily understand the contents that the user of the other terminal intended to present.

According to this embodiment, in order to explain the drawn contents to be shared between the information processing apparatuses, a trail (drawn as, e.g. an underline) which fades out after the drawing may be displayed as an annotation.

According to this embodiment, the user can identify temporarily drawn contents and permanently drawn contents while assuring a time period until the temporarily drawn contents fade out by controlling the drawing processing, update processing, and fade-out processing of the drawn contents based on the drawing data of respective information processing apparatuses.

### Second Exemplary Embodiment

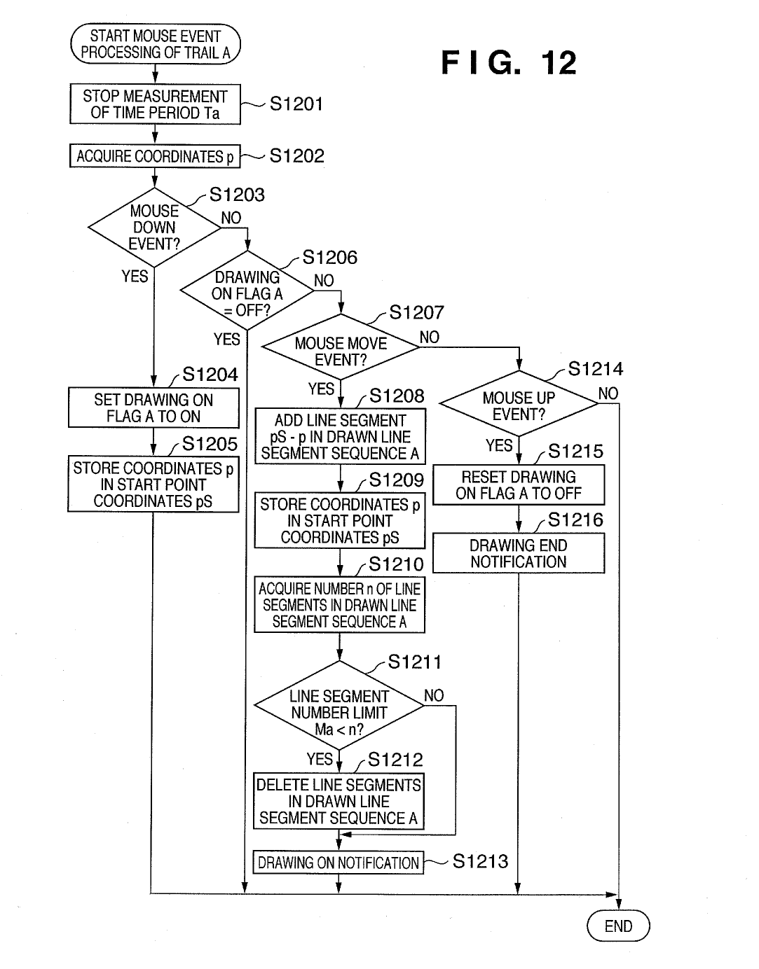

The second embodiment of the present invention will be described hereinafter with reference to FIGS. 12 to 19. In this embodiment, the mouse event processing of trail A, the fade-out processing of trail A, the drawing processing of trail B, the fade-out processing of trail B, and the update processing of the drawn contents are different from those of the first embodiment.

(Mouse Event Processing of Trail A)

The mouse event processing of trail A according to the second embodiment will be described below with reference to the drawings. This processing corresponds to that in step S303 described in the first embodiment. FIG. 12 is a flowchart for explaining the procedure of the detailed mouse event processing of trail A according to the second embodiment. Note that the display controller 207a and communication controller 208a execute the following processing under the total control of the CPU 201a.

In step S1201, the timer 203a stops measurement of time period Ta until the drawn contents on the display 205a of the self terminal fade out.

In step S1202, the CPU 201a acquires coordinates p(xp, yp) designated by a mouse event. The CPU 201a determines in step S1203 if the received mouse event is a mouse down event from the pointing device 204a. If the received event is not a mouse down event (NO in step S1203), the process advances to step S1206; otherwise (YES in step S1203), the process advances to step S1204.

In step S1204, the CPU 201a sets flag A indicating that drawing of trail A is in progress to ON.

In step S1205, the CPU 201a stores the data of coordinates p in start point coordinates pS of drawn line segment sequence A (FIG. 15), thus ending the processing for storing data required to draw trail A.

On the other hand, the CPU 201a determines in step S1206 if the flag A is OFF. If the flag A is OFF (YES in step S1206), the CPU 201a ends the mouse event processing of trail A. If the flag A is not OFF (NO in step S1206), the CPU 201a determines in step S1207 if the received event is a mouse move event from the pointing device 204a.

If the received event is not a mouse move event (NO in step S1207), the process advances to step S1214.

On the other hand, if the received event is a mouse move event (YES in step S1207), the CPU 201a stores the coordinates of end point p of line segment pS (start point)-p (end point) at the rearmost address of drawn line segment sequence A (FIG. 15) indicating trail A (step S1208). In step S1209, the CPU 201a stores the coordinates of end point p in start point coordinates pS of the next line segment.

FIG. 15 shows an example of drawn line segment sequence A used to store line segment data (coordinates of start and end points) required to display trail A. A drawn line segment sequence A 1501 can store the start and end point coordinates of line segments input by the pointing device 204a in turn. For example, a start point (x0, y0) and end point (x1, y1) are stored as one line segment input by the pointing device 204a. In FIG. 15, since the end point of a line segment 1502 matches the start point of a line segment 1503, the line segments 1502 and 1503 are continuous. On the other hand, since the end point of the line segment 1503 does not match the start point of a line segment 1504, the line segments 1503 and 1504 are discontinuous.

In case of a continuous trail, the end point of a given line segment has the same coordinates as the start point of the next line segment that follows the given line segment. For this reason, the data in the drawn line segment sequence A 1501 can be expressed as flags each indicating whether or not the coordinates input by the pointing device 204a are continuous with the immediately preceding coordinates.

In step S1210, the CPU 201a acquires the number n of line segments stored in the drawn line segment sequence A 1501. The CPU 201a then determines in step S1211 if the number n of line segments acquired from the drawn line segment sequence A 1501 exceeds a line segment number limit Ma of trail A. If the number n of line segments exceeds the line segment number limit Ma of trail A (YES in step S1211), the CPU 201a sequentially deletes line segments from those (the number n of line segments) stored in the drawn line segment sequence A 1501 by the number which has exceeded the line segment number limit Ma in step S1212. If the number of line segments has exceeded the line segment number limit Ma, a corresponding number of oldest line segment data stored in the drawn line segment sequence A 1501 are deleted.

Of the number n of line segments stored in the drawn line segment sequence A 1501, display of trail A undergoes display control to have the line segment number limit Ma as an upper limit. Every time new line segment data (start and end points) is added to the drawn line segment sequence A 1501, the oldest line segment data is deleted sequentially. The display controller 207a controls to fade out display corresponding to the oldest line segment data, and controls to display trail A corresponding to the new line segment data added to the drawn line segment sequence A 1501 on the display 205a.

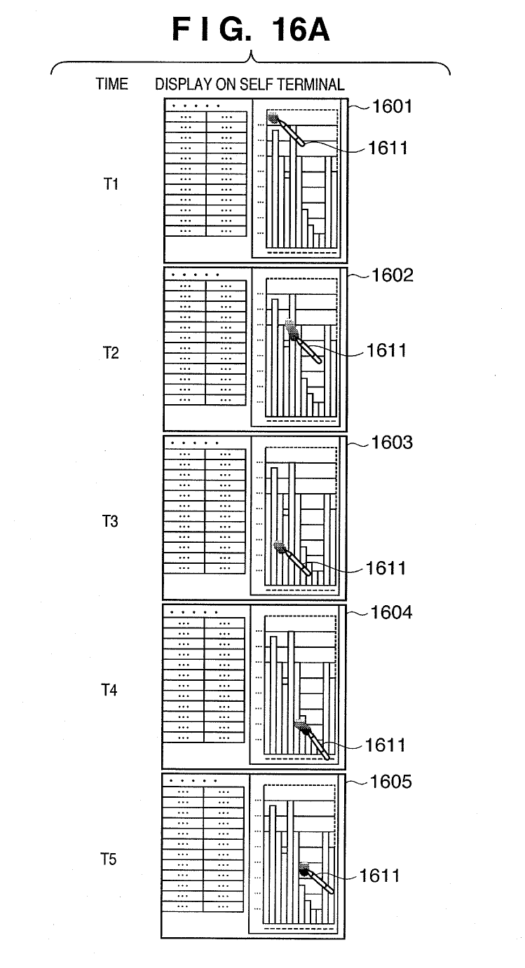

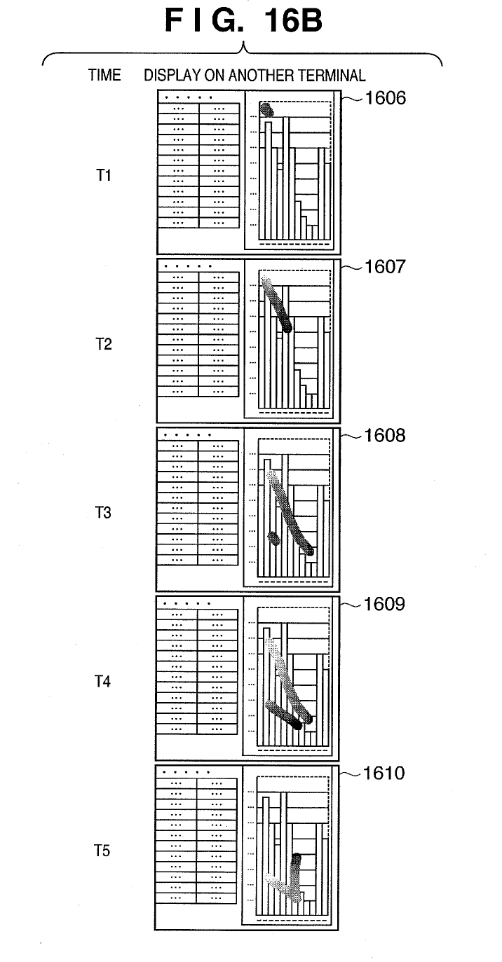

FIG. 16A shows an example of the displayed contents on the display 205a. Reference numerals 1601 to 1605 denote drawing states on the self terminal (information processing apparatus 102), on which drawing is underway, in a time series (T1 to T5). On the drawing states 1601 to 1605, reference numeral 1611 denotes a cursor displayed on the display 205a of the information processing apparatus 102, and trail A is drawn on the display 205a by dragging this cursor. Trail A, which is drawn by dragging the cursor 1611, is drawn as a trail of line segments for the line segment number limit Ma while tracing back from the latest line segment under the control of the display controller 207a. FIG. 16B shows an example of the displayed contents on the display 205b of the other terminal. Reference numerals 1606 to 1610 denote drawing states of the contents drawn on the self terminal (information processing apparatus 102) in a time series (T1 to T5).

Referring back to FIG. 12, in step S1213 the CPU 201a sends a drawing ON notification indicating that drawing is in progress on the self terminal to the other information processing apparatus 103 via the LAN interface 206a, thus ending the processing of trail A.

On the other hand, the CPU 201a determines in step S1214 if the received event is a mouse up event from the pointing device 204a. If the received event is a mouse up event (YES in step S1214), the process advances to step S1215. On the other hand, if the received event is not a mouse up event (NO in step S1214), the processing ends.

In step S1215, the CPU 201a resets the A indicating that drawing of trail A is in progress to OFF. In step S1216, the CPU 201a sends a drawing end notification indicating that drawing has ended to the information processing apparatus 103 via the LAN interface 206a, thus ending the processing of trail A.

(Fade-Out Processing of Trail A)

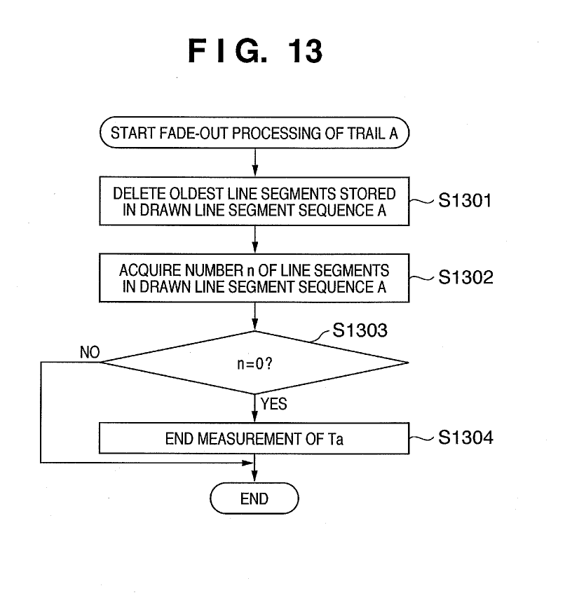

The fade-out processing of trail A according to this embodiment will be described below. This processing corresponds to that in step S313 described in the first embodiment. FIG. 13 is a flowchart for explaining the procedure of the detailed fade-out processing. Note that the display controller 207a and communication controller 208a execute the fade-out processing under the total control of the CPU 201a.

In step S1301, the CPU 201a deletes the oldest line segments stored in the drawn line segment sequence A 1501 (line segments stored at earlier addresses of the drawn line segment sequence A 1501) in response to an elapse of time period Ta measured by the timer 203a. That is, the CPU 201a sequentially deletes the oldest line segments stored in the drawn line segment sequence A 1501 in turn every time period Ta from the beginning of time measurement of the timer 203a.

In step S1302, the CPU 201a acquires the number n of line segments in the drawn line segment sequence A 1501.

The CPU 201a determines in step S1303 if the number of line segments acquired in previous step S1302 zero. If the number of line segments is not zero (NO in step S1303), the CPU 201a ends the fade-out processing. On the other hand, if the number of line segments is zero (YES in step S1303), the timer 203a ends measurement of time period Ta in step S1304, thus ending the fade-out processing.

(Drawing Processing of Trail B)

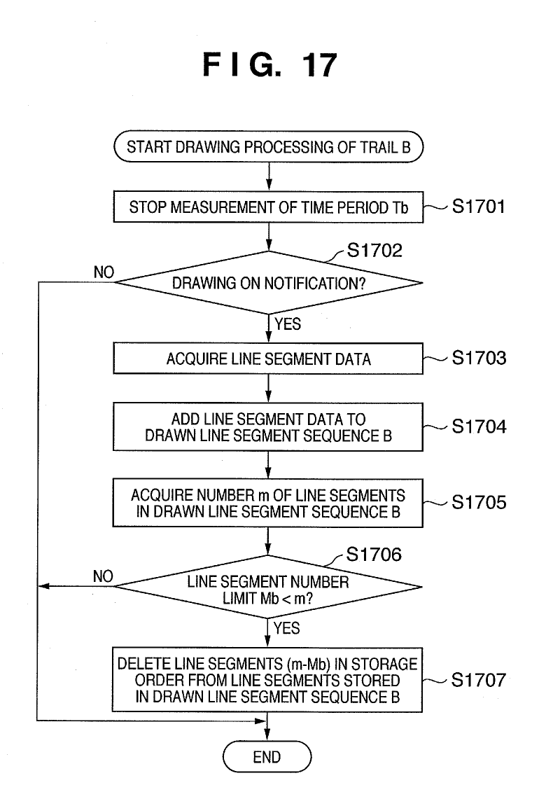

The drawing processing of trail B according to this embodiment will be described below. This processing corresponds to that in step S308 described in the first embodiment. FIG. 17 is a flowchart for explaining the procedure of the drawing processing of trail B according to this embodiment, and the procedure of the detailed processing will be described below with reference to FIG. 17. Note that the display controller 207a and communication controller 208a execute the drawing processing of trail B under the total control of the CPU 201a.

In step S1701, the timer 203a stops measurement of time period Tb required to fade out the drawn contents on the other terminal.

The CPU 201a then determines in step S1702 if the received event is a drawing ON notification event sent from the information processing apparatus 103 via the LAN interface 206a. If the received event is not a drawing ON notification event (NO in step S1702), the CPU 201a ends this processing. If the received event is a drawing ON notification (YES in step S1702), the process advances to step S1703, and the CPU 201a acquires line segment data (start and end point data of line segments) via the LAN interface 206a.

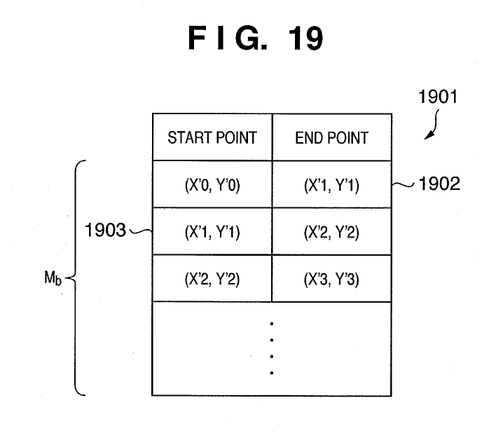

In step S1704, the CPU 201a sequentially adds the line segment data sent from the other terminal (in this case, the information processing apparatus 103) at the rearmost address of an area (drawn line segment sequence B) used to store the line segment data sent from the other terminal. FIG. 19 shows an example of a drawn line segment sequence B 1901 used to store line segment data (the coordinates of start and end points) required to display trail B. The drawn line segment sequence B 1901 stores line segment data (the coordinates of the start and end points of line segments) sent from the other terminal. For example, since end point coordinates 1902 of a line segment stored first match start point coordinates 1903 of a line segment stored next, these two line segments are continuous.

In step S1705, the CPU 201a acquires the number m of line segments stored in the drawn line segment sequence B 1901.

The CPU 201a then determines in step S1706 if the number m of line segments acquired from the drawn line segment sequence B 1901 exceeds the line segment number limit Mb of trail B. If the number m of line segments does not exceed the line segment number limit Mb (NO in step S1706), the CPU 201a ends this processing, and starts the next update processing of the drawn contents.

On the other hand, if the number m of line segments exceeds the line segment number limit Mb of trail B (YES in step S1706), the process advances to step S1707. The CPU 201a deletes the oldest line segments from the drawn line segment sequence B 1901 in turn by the number (m-Mb) of line segments which has exceeded the line segment number limit Mb, thus ending this processing. Since the oldest line segment data is deleted every time new line segment data is added to have the line segment number limit Mb as an upper limit, display of trail B corresponding to the oldest line segment data fades out.

Assuming that FIG. 16A shows trail A drawn on the display 205b of the information processing apparatus 103, FIG. 16B shows the display state of the drawn contents of the other terminal (information processing apparatus) on the display 205a of the information processing apparatus 102 as trail B. As trail B, line segments stored in drawn line segment sequence B tracing back from the latest line segment (the line segment stored in drawn line segment sequence B last) by the line segment number limit Mb are drawn.

The line segment number limits Ma and Mb can respectively have different settings. Therefore, by setting a small line segment number limit Ma to fade out trail A at once, the user can easily decide as to whether trail A is drawn temporarily or permanently. On the other hand, by setting a large line segment number limit Mb to slowly fade out trail B, the user can easily understand the contents that the user of the other terminal intended to present.

For example, if the line segment number limit Ma required to display trail A is set to be zero, and the line segment number limit Mb required to display trail B is set to meet Mb>0, no trail A is displayed on the display 205a on the self terminal side, and the drawn contents of the other terminal are displayed as trail B.

Assume that the line segment number limit Mb of trail B is set to be a maximum value that the information processing apparatus 103 can process. In this case, the trail is controlled to fade out on the display 205a on the self terminal side, and the trail is controlled not to fade out on the display 205b of the information processing apparatus 103 on the other terminal side until the drawing operation ends. Since the trail remains on the display 205b until the drawing operation ends, a text-based annotation can be displayed.

(Fade-Out Processing of Trail B)

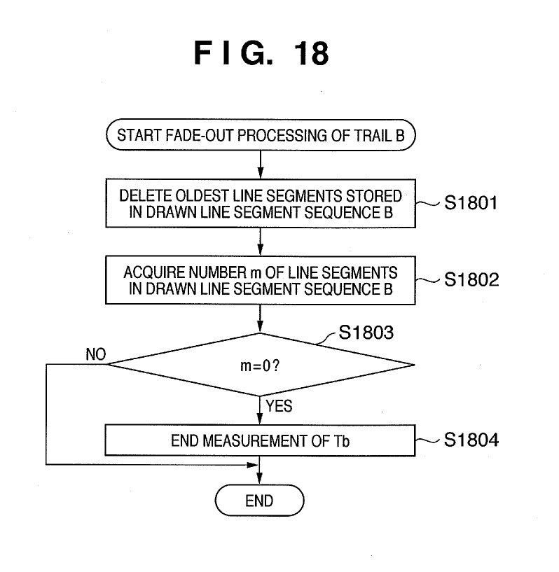

The fade-out processing of trail B according to this embodiment will be described below. This processing corresponds to that in step S316 described in the first embodiment. FIG. 18 is a flowchart for explaining the procedure of the fade-out processing of trail B according to this embodiment, and the detailed processing will be described below with reference to FIG. 18. Note that the display controller 207a and communication controller 208a execute the fade-out processing of trail B under the total control of the CPU 201a.

In step S1801, the CPU 201a deletes the oldest line segment data (line segments stored at earlier addresses in the drawn line segment sequence 1901) of those which are stored in drawn line segment sequence B in response to an elapse of time period Tb measured by the timer 203a. That is, the oldest line segment data stored in drawn line segment sequence B are deleted every time period Tb from the beginning of time measurement of the timer 203a.

In step S1802, the CPU 201a acquires the number m of line segments in the drawn line segment sequence B 1901.

The CPU 201a determines in step S1803 if the number m of line segments in the drawn line segment sequence B obtained in step S1802 is zero. If the number m of line segments is not zero (NO in step S1803), the CPU 201a ends the fade-out processing. On the other hand, if the number m of line segments is zero (YES in step S1803), the timer 203a ends measurement of time period Tb in step S1804, thus ending the fade-out processing.

(Update Drawn Contents)

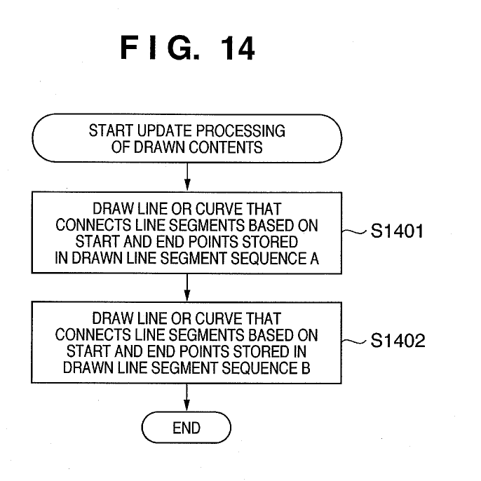

The update processing of the drawn contents of trails A and B will be described below. This processing corresponds to that in each of steps S304, S309, S314, and S317 described in the first embodiment. FIG. 14 is a flowchart for explaining the procedure of the update processing of the drawn contents according to this embodiment, and the procedure of the detailed processing will be described below with reference to FIG. 14. Note that the display controller 207a and communication controller 208a execute the update processing of the drawn contents under the total control of the CPU 201a.

In step S1401, the CPU 201a reads out start and end point data stored in the drawn line segment sequence A 1501 and controls to display drawn contents by connecting respective line segments based on the readout start and end point data by a straight line or curve on the display 205a as trail A.

In step S1402, the CPU 201a reads out start and end point data stored in the drawn line segment sequence B 1901 and controls to display drawn contents by connecting respective line segments based on the readout start and end point data by a straight line or curve on the display 205a as trail B.

Upon displaying trails A and B, the display controller 207a can change display of the color, width, and the like of the line segments based on the order line segments were stored in the respective drawn line segment sequences. Upon identifiably displaying trails A and B, the visual effect of the fade-out processing can be improved.

As an example of improving the visual effect, for example, the latest line segment may be displayed opaque, and the transparency of line segments may increase as their storage order becomes older. Alternatively, line segments between the latest line segment and the oldest line segment in the order they were stored may be displayed as a gradation pattern. Furthermore, the latest line segment may be drawn as a bold line, and the line width of the line segments may get thinner as they become older. Moreover, the latest line segment may be drawn as a dotted line with a narrow dot interval, and the dot interval may become broader as they become older. In this way, dotted lines with dots that are either positioned close together or far apart are visually displayed, thus improving the visual effect of the fade-out processing.

With the visual effect of the fade-out processing, the user can recognize that trails A and B fade out as an elapse of time, and can perceive a time period until the trails fade out.

This embodiment has explained the example in which trail B based on drawing data from the other terminal (information processing apparatus 103) is displayed in addition to trail A of the self terminal (information processing apparatus 102). The gist of the present invention is not limited to such specific example. The present invention can be similarly applied to a case wherein the information processing apparatus 103 is defined as a self terminal, drawn contents on the information processing apparatus 103 are defined as trail A, and trail B based on drawing data received from the information processing apparatus 102 as the other terminal is displayed.

Furthermore, the contents drawn on other terminals in the arrangement including more information processing apparatuses can be added as trail C, trail D, and the like, and these trails can be identifiably displayed on one display. In this case, the memory 202a includes drawn line segment sequences C, D, and the like used to store corresponding drawing data, so that the display controller 207a can display the drawing data stored in the respective drawn line segment sequences on the display 205a. By exchanging drawing data among a plurality of information processing apparatuses, the contents drawn on the display can be shared.

The line segment number limit Ma of trail A and the line segment number limit Mb of trail B can be set for respective information processing apparatuses. When the user wants to perform a drawing operation on the self terminal without drawing any trail of the other terminal, Mb is set to be zero not to draw any trail from the other terminal. When the line segment number limit Mb of the other terminal, which is set in the self terminal is set to have the same value as the line segment number limit Ma of the self terminal, the same screen display contents can be displayed on the displays of the self terminal and the other terminal.

According to this embodiment, in order to explain the drawn contents to be shared between the information processing apparatuses, a trail (drawn as, e.g., a figure formed of line segments) which fades out after drawing may be displayed as an annotation.

According to this embodiment, the user can identify temporarily drawn contents and permanently drawn contents while assuring a time period until the temporarily drawn contents fade out by controlling the drawing processing, update processing, and fade-out processing of the drawn contents based on the drawing data of respective information processing apparatuses.

### Third Exemplary Embodiment

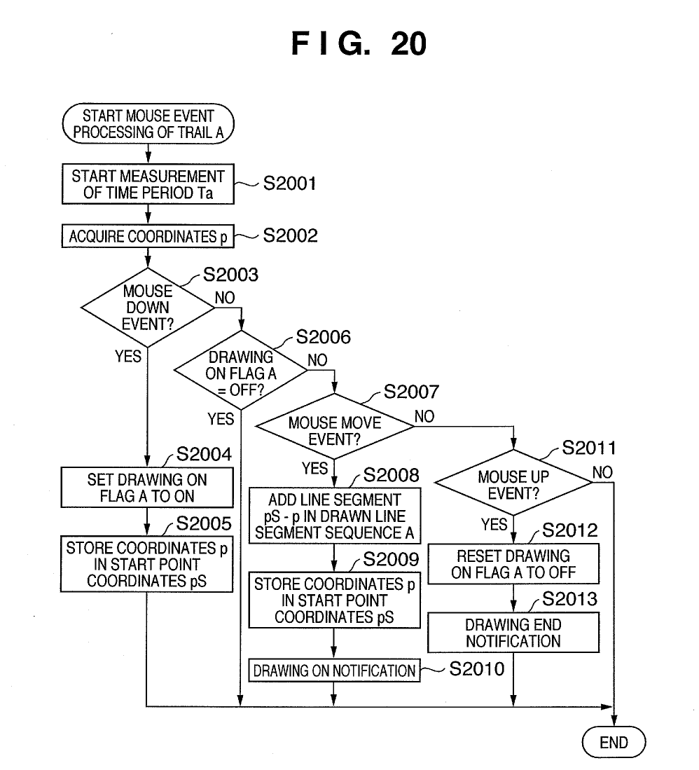

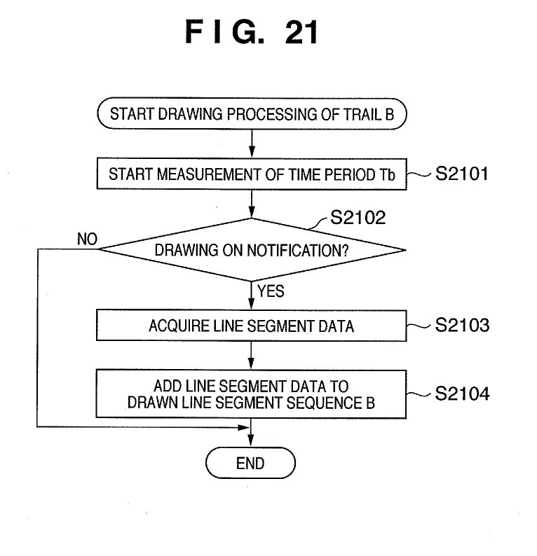

The third embodiment of the present invention will be described below with reference to FIGS. 20 and 21. In this embodiment, the mouse event processing of trail A and the drawing processing of trail B are different from the second embodiment.

(Mouse Event Processing of Trail A)

The mouse event processing of trail A according to the third embodiment will be described below with reference to the drawings. This processing corresponds to that in step S303 described in the first embodiment. FIG. 20 is a flowchart for explaining the procedure of the detailed mouse event processing of trail A according to the third embodiment. Note that the display controller 207a and communication controller 208a execute the mouse event processing of trail A under the total control of the CPU 201a.

In step S2001, the timer 203a starts measurement of time period Ta if it stops time measurement. In this embodiment, the line segment number limit Ma to be stored in drawn lien segment sequence A is not limited, and the number of lines is reduced every time period Ta.

In step S2002, the CPU 201a acquires coordinates p(xp, yp) designated by a mouse event. The CPU 201a determines in step S2003 if the received mouse event is a mouse down event from the pointing device 204a. If the received event is not a mouse down event (NO in step S2003), the process advances to step S2006; otherwise (YES in step S2003), the process advances to step S2004.

In step S2004, the CPU 201a sets flag A indicating that drawing of trail A is in progress to ON.

In step S2005, the CPU 201a stores the data of coordinates p in start point coordinates pS of drawn line segment sequence A (FIG. 15), thus ending the processing for storing data required to draw trail A.

On the other hand, the CPU 201a determines in step S2006 if the flag A is OFF. If the flag A is OFF (YES in step S2006), the CPU 201a ends the mouse event processing of trail A. If the flag A is not OFF (NO in step S2006), the CPU 201a determines in step S2007 if the received event is a mouse move event from the pointing device 204a.

If the received event is not a mouse move event (NO in step S2007), the process advances to step S2011.

On the other hand, if the received event is a mouse move event (YES in step S2007), the CPU 201a stores the coordinates of end point p of line segment pS (start point)-p (end point) at the rearmost address of drawn line segment sequence A (FIG. 15) indicating trail A (step S2008). In step S2009, the CPU 201a stores the coordinates of end point p in start point coordinates pS of the next line segment.

In step S2010, the CPU 201a sends a drawing ON notification indicating that drawing is in progress on the self terminal to the other information processing apparatus 103 via the LAN interface 206a, thus ending the processing of trail A.

The CPU 201a determines in step S2011 if the received event is a mouse up event from the pointing device 204a. If the received event is a mouse up event (YES in step S2011), the process advances to step S2012. On the other hand, if the received event is not a mouse up event (NO in step S2011), the processing ends.

In step S2012, the CPU 201a resets the flag A indicating that drawing of trail A is in progress to OFF. In step S2013, the CPU 201a sends a drawing end notification indicating that drawing has ended to the information processing apparatus 103 via the LAN interface 206a, thus ending the processing of trail A.

(Drawing Processing of Trail B)

The drawing processing of trail B according to this embodiment will be described below. This processing corresponds to that in step S308 described in the first embodiment. FIG. 21 is a flowchart for explaining the procedure of the drawing processing of trail B according to this embodiment, and the procedure of the detailed processing will be described below with reference to FIG. 21. Note that the display controller 207a and communication controller 208a execute the drawing processing of trail B under the total control of the CPU 201a.

In step S2101, the timer 203a starts measurement of time period Tb if it stops time measurement. In this embodiment, the line segment number limit Mb to be stored in drawn lien segment sequence B is not limited, and the number of lines is reduced every time period Tb.

The CPU 201a then determines in step S2102 if the received event is a drawing ON notification event sent from the information processing apparatus 103 via the LAN interface 206a. If the received event is not a drawing ON notification event (NO in step S2102), the CPU 201a ends this processing. If the received event is a drawing ON notification (YES in step S2102), the process advances to step S2103, and the CPU 201a acquires line segment data (start and end point data of line segments) via the LAN interface 206a.

In step S2104, the CPU 201a sequentially adds the line segment data sent from the other terminal (in this case, the information processing apparatus 103) at the rearmost address of an area (the drawn line segment sequence B 1901 shown in FIG. 19) used to store the line segment data sent from the other terminal, thus ending the processing.

According to this embodiment, the drawing processing of the other terminal can be controlled based on the measured values (Ta, Tb) of the timer 203a irrespective of the limitations of the line segment number limits (Ma, Mb). Under the control of the CPU 201a, the display controller 207a executes the fade-out processing of trails A and B in response to elapses of time periods Ta and Tb from the beginning of time measurement by the timer 203a, and can update trails A and B.

This embodiment has explained the example in which trail B based on drawing data from the other terminal (information processing apparatus 103) is displayed in addition to trail A of the self terminal (information processing apparatus 102). The gist of the present invention is not limited to such specific example. The present invention can be similarly applied to a case wherein the information processing apparatus 103 is defined as a self terminal, drawn contents on the information processing apparatus 103 are defined as trail A, and trail B based on drawing data received from the information processing apparatus 102 as the other terminal is displayed.

Furthermore, the contents drawn on other terminals in the arrangement including more information processing apparatuses can be added as trail C, trail D, and the like, and these trails can be identifiably displayed on one display. In this case, the memory 202a includes drawn line segment sequences C, D, and the like used to store corresponding drawing data, so that the display controller 207a can display the drawing data stored in the respective drawn line segment sequences on the display 205a. By exchanging drawing data among a plurality of information processing apparatuses, the contents drawn on the display can be shared.

According to this embodiment, the user can identify temporarily drawn contents and permanently drawn contents while assuring a time period until the temporarily drawn contents fade out by controlling the drawing processing, update processing, and fade-out processing of the drawn contents based on the drawing data of respective information processing apparatuses.

### Fourth Exemplary Embodiment

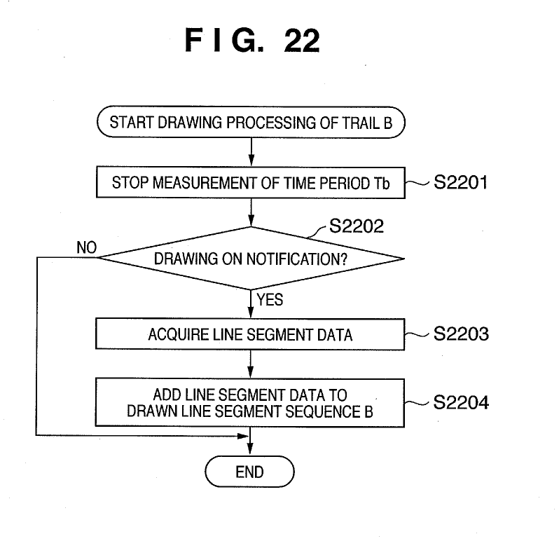

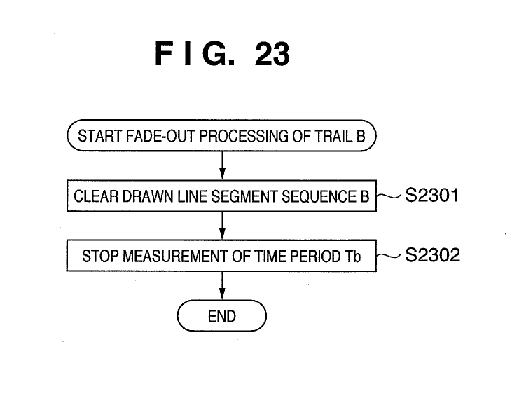

The fourth embodiment of the present invention will be described hereinafter with reference to FIGS. 22 and 23. In this embodiment, the drawing processing and the fade-out processing of trail B are different from the second embodiment.

(Drawing Processing of Trail B)

The drawing processing of trail B according to this embodiment will be described below. This processing corresponds to that in step S308 described in the first embodiment. FIG. 22 is a flowchart for explaining the procedure of the drawing processing of trail B according to this embodiment, and the procedure of the detailed processing will be described below with reference to FIG. 22. Note that the display controller 207a and communication controller 208a execute the drawing processing of trail B under the total control of the CPU 201a.

In step S2201, the timer 203a stops measurement of time period Tb required to fade out the drawn contents on the other terminal.

The CPU 201a then determines in step S2202 if the received event is a drawing ON notification event sent from the information processing apparatus 103 via the LAN interface 206a. If the received event is not a drawing ON notification event (S2202—No), the CPU 201a ends this processing. If the received event is a drawing ON notification (S2202—Yes), the process advances to step S2203, and the CPU 201a acquires line segment data (start and end point data of line segments) via the LAN interface 206a.

In step S2204, the CPU 201a sequentially adds the line segment data sent from the other terminal (in this case, the information processing apparatus 103) at the rearmost address of an area (the drawn line segment sequence B 1901 in FIG. 19) used to store the line segment data sent from the other terminal, thus ending the processing.

(Fade-Out Processing of Trail B)

The fade-out processing of trail B according to this embodiment will be described below. This processing corresponds to that in step S316 described in the first embodiment. FIG. 23 is a flowchart for explaining the procedure of the fade-out processing of trail B according to this embodiment, and the detailed processing will be described below with reference to FIG. 23. Note that the display controller 207a and communication controller 208a execute the fade-out processing of trail B under the total control of the CPU 201a.

In step S2301, the CPU 201a clears the drawn line segment sequence B 1901. In step S2302, the timer 203a ends measurement of time period Tb, thus ending the fade-out processing.

According to this embodiment, the drawing processing on the other terminal can be controlled based on the measured value Tb of the timer 203a irrespective of the limitation of the line segment number limit Mb. Under the control of the CPU 201a, the display controller 207a keeps displaying trail B which is continuously drawn without any time interval equal to or longer than time period Tb. If a time interval equal to or longer than time period Tb is formed, the display controller 207a executes the fade-out processing of trail B, thus updating trail B.

Since this embodiment limits the length of trail A by line segment number limit Ma, trail A is displayed to fade out after the drawing operation. Of course, the same processing may be applied to trail A as in trail B, and trail A, which is continuously drawn without any time interval equal to or longer than time period Tb, can be kept displayed.

This embodiment has explained the example in which trail B based on drawing data from the other terminal (information processing apparatus 103) is displayed in addition to trail A of the self terminal (information processing apparatus 102). The gist of the present invention is not limited to such specific example. The present invention can be similarly applied to a case wherein the information processing apparatus 103 is defined as a self terminal, drawn contents on the information processing apparatus 103 are defined as trail A, and trail B based on drawing data received from the information processing apparatus 102 as the other terminal is displayed.

Furthermore, the contents drawn on other terminals in the arrangement including more information processing apparatuses can be added as trail C, trail D, and the like, and these trails can be identifiably displayed on one display. In this case, the memory 202a includes drawn line segment sequences C, D, and the like used to store corresponding drawing data, so that the display controller 207a can display the drawing data stored in the respective drawn line segment sequences on the display 205a. By exchanging drawing data among a plurality of information processing apparatuses, the contents drawn on the display can be shared.

According to this embodiment, in order to explain the drawn contents to be shared between the information processing apparatuses, a trail which fades out after drawing may be displayed as a text-based annotation in addition to a figure formed of line segments.

In the first to fourth embodiments, the procedure of the overall drawing processing follows the flowchart shown in FIG. 3. The second, third, and fourth embodiments control display of trails A and B by adopting different processing steps as partial processing steps of the flowchart in FIG. 3. The self terminal and the other terminal may execute either the same or different procedures of the drawing processing. For example, the self terminal may execute the drawing processing of the first embodiment, and the other terminal may execute the drawing processing of the second, third, or fourth embodiment.

According to this embodiment, the user can identify temporarily drawn contents and permanently drawn contents while assuring a time period until the temporarily drawn contents fade out by controlling the drawing processing, update processing, and fade-out processing of the drawn contents based on the drawing data of respective information processing apparatuses.

### Fifth Exemplary Embodiment

In the first to fourth embodiments, the drawing processing of the self terminal is controlled based on the mouse event input by the pointing device 204a and the time-out event upon elapse of time period Ta measured by the timer 203a. On the other hand, the drawing processing of the other terminal is controlled based on the drawing notification sent from the other terminal and the time-out event upon elapse of time period Tb measured by the timer 203a.

This embodiment sets identification information (IDs) used to specify the information processing apparatuses 102, 103, and the like, and allows the information processing apparatuses to exchange information as a pair of the ID and mouse event with each other, and to process the generated event according to the ID. By setting the coordinate number limits, line segment number limits, and time-out time periods in correspondence with the IDs, the drawing processing on the self terminal and that on the other terminal are not separated as independent events, and the events generated on the self terminal and the other terminal can be integrally processed according to the IDs.

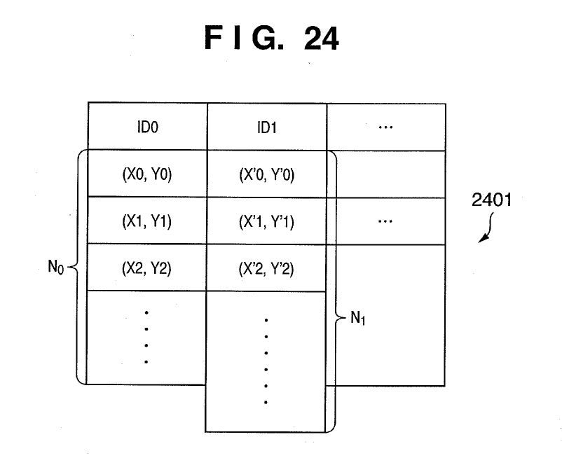

FIG. 24 shows an example of a drawn coordinate sequence according to this embodiment. The drawn coordinate sequence stores coordinate data of drawn contents in correspondence with identification information (ID=0, 1, 2, . . . ) used to identify each information processing apparatus. Also, a coordinate number limit Ni (i=0, 1, 2, . . . ) is set in correspondence with each ID.

The number of coordinate points to be stored in the drawn coordinate sequence corresponding to each ID can be controlled in accordance with the coordinate number limit Ni (i=0, 1, 2, . . . ). Storage of coordinate data of drawn contents corresponding to the identification information (ID=0, 1, 2, . . . ) and deletion of data which exceed the coordinate number limit Ni (i=0, 1, 2, . . . ) can be managed based on each ID.

A time-out time period (T0, T1, T2, . . . ) is set for each ID, and the elapse of the time-out time period is controlled for each ID, thus executing the fade-out processing of a trail and update processing of drawn contents in correspondence with each ID.

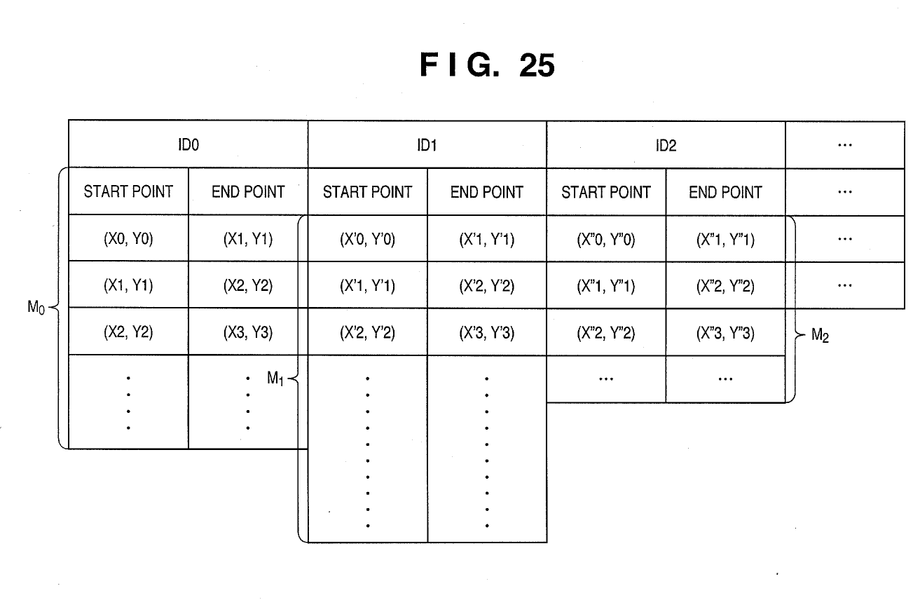

FIG. 25 shows an example of a drawn line segment sequence according to this embodiment. The drawn line segment sequence stores line segment data (coordinates of start and end points) of drawn contents in correspondence with identification information (ID=0, 1, 2, . . . ) used to identify each information processing apparatus. Also, a line segment number limit Mi (i=0, 1, 2, . . . ) is set in correspondence with each ID.

The number of line segments to be stored in the drawn line segment sequence corresponding to each ID can be controlled in accordance with the line segment number limit Mi (i=0, 1, 2, . . . ). Storage of line segment data of drawn contents corresponding to the identification information (ID=0, 1, 2, . . . ) and deletion of data which exceed the line segment number limit Mi (i=0, 1, 2, . . . ) can be managed based on each ID.

In the first to fifth embodiments, the update processing of drawing data can be executed in drawn coordinate units, line segment units (stroke units), or drawn object units formed of a plurality of line segments.

### Other Embodiments

Note that the objects of the present invention are also achieved by supplying a storage medium, which records a program code of a software program that can implement the functions of the above-mentioned embodiments to a system or apparatus. Also, the objects of the present invention are also achieved by reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a flexible disk, hard disk, optical disk, magneto-optical disk, CD-ROM, CD-R, nonvolatile memory card, ROM, and the like may be used.

The functions of the above-mentioned embodiments may be implemented by executing the readout program code by the computer. Also, functions of the above-mentioned embodiments may be implemented by some or all of actual processing operations executed by an OS (operating system) running on the computer on the basis of an instruction of the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-023621, filed Jan. 31, 2006 and Japanese Patent Application No. 2006-335080, filed Dec. 12, 2006, which are hereby incorporated by reference herein in their entirety.

What is claimed is:

1. A method in an information processing apparatus which transmits and receives drawing data with another information processing apparatus coupled via a network and can share display contents to be displayed on a display unit based on each other's drawing data, the method comprising:
inputting the drawing data;
storing first drawing data input and second drawing data received via the network, the first drawing data and the second drawing data stored in a storage unit;
updating the first drawing data stored in the storage unit;
updating the second drawing data stored in the storage unit; and
displaying, on the display unit, first display contents based on the updated first drawing data and second display contents based on the updated second drawing data.

2. The method according to claim 1, wherein the updating of the first drawing data includes updating the first drawing data by deleting the first drawing data which has an older storage order in the storage unit and adding newly stored first drawing data to have a first limit value that limits the number of first drawing data to be stored in the storage unit as an upper limit.

3. The method according to claim 1, further comprising:
measuring a time period required to update the first drawing data using a first timer used to measure the time period, and
wherein the updating of the first drawing data includes deleting the first drawing data, which has an older storage order in the storage unit, upon an elapse of a predetermined time period.

4. The method according to claim 2, wherein the updating of the first drawing data includes updating the first drawing data stored in the storage unit for respective drawn coordinates.

5. The method according to claim 2, wherein the updating of the first drawing data includes updating the first drawing data stored in the storage unit for respective drawn strokes.

6. The method according to claim 2, wherein the updating of the first drawing data includes updating the first drawing data stored in the storage unit for respective drawn objects.

7. The method according to claim 1, wherein the updating of the second drawing data includes updating the second drawing data by deleting the second drawing data which has an older storage order in the storage unit and adding newly stored second drawing data to have a second limit value that limits the number of second drawing data to be stored in the storage unit as an upper limit.

8. The method according to claim 1, further comprising:
measuring a time period required to update the second drawing data using a second timer used to measure the time period, and
wherein the updating of the second drawing data includes deleting the second drawing data, which has an older storage order in the storage unit, upon an elapse of a predetermined time period.

9. The method according to claim 7, wherein the updating of the second drawing data includes updating the second drawing data stored in the storage unit for respective drawn coordinates.

10. The method according to claim 7, wherein the updating of the second drawing data includes updating the second drawing data stored in the storage unit for respective drawn strokes.

11. The method according to claim 7, wherein the updating of the second drawing data includes updating the second drawing data stored in the storage unit for respective drawn objects.

12. The method according to claim 1, wherein the displaying of the display contents includes controlling to fade out display contents based on the first drawing data and the second drawing data deleted during the updating of the first drawing data and the updating of the second drawing data.

13. The method according to claim 12, wherein the first display contents and the second display contents have at least one of different transparencies, different gradation patterns of display contents, different widths of display contents, and coarse and fine dotted lines which form display contents.

14. An information processing apparatus which transmits and receives drawing data with another information processing apparatus connected via a network and can share display contents to be displayed on a display unit based on each other's drawing data, the information processing apparatus comprising:
an input unit configured to input the drawing data;
a storage unit configured to store first drawing data input by the input unit and second drawing data received via the network;
a first data update unit configured to update the first drawing data stored in the storage unit;
a second data update unit configured to update the second drawing data stored in the storage unit; and
a display control unit configured to display, on the display unit, first display contents based on the first drawing data updated by the first data update unit and second display contents based on the second drawing data updated by the second data update unit.

15. A computer-readable medium storing instruction which, when executed by an apparatus, causes the apparatus to perform operations comprising:
receiving first drawing data and second drawing data via the network;
storing the first drawing data and the second drawing data in a storage unit;
updating the first drawing data stored in the storage unit;
updating the second drawing data stored in the storage unit; and
displaying, on the display unit, first display contents based on the updated first drawing data and second display contents based on the updated second drawing data.
